(19) United States
(12) Patent Application Publication
(10) Pub. No.: US 2019/0207308 A1
(43) Pub. Date: Jul. 4, 2019

(54) EFFECIENT HYBRID ELECTRONICAL AND MECHANICAL CONTROL BEAM POTING VEHICLE ANTENNA FOR SATELLITE COMMUNICATION

(71) Applicants: Gary Gwoon Wong, Torrance, CA (US); Kalem Gwoon Wong, Torrance, CA (US); Samuel Wahon Wong, Torrance, CA (US)

(72) Inventors: Gary Gwoon Wong, Torrance, CA (US); Kalem Gwoon Wong, Torrance, CA (US); Samuel Wahon Wong, Torrance, CA (US)

(21) Appl. No.: 16/009,365

(22) Filed: Jun. 15, 2018

Related U.S. Application Data
(60) Provisional application No. 62/708,875, filed on Dec. 28, 2017.

(51) Int. Cl. H01Q 3/20; H01Q 1/27; H01Q 1/36; H01Q 21/24; H01Q 1/42; H01Q 15/16

(52) U.S. Cl. CPC H01Q 3/20; H01Q 1/27; H01Q 15/16; H01Q 21/24; H01Q 1/42; H01Q 1/36

(57) ABSTRACT

A highly efficient electronical and mechanical beam pointing vehicle antenna is disclosed. The structure is designed for a vehicle to maintain continued communication with a satellite while the vehicle is in motion. The structure is comprised of a group of left and right hand circularly polarized elements which are located and fixed to the center of the antenna structure. These feed elements are stacked and are electronically phased to obtain the elevation pointing. The feeds are wrapped around by a vane type polarizer which is designed to provide simultaneous operation of left and right hand circularly polarized signals and the radiation of the feed elements are symmetrically radiated over the entire 360 degree horizontal field of view. A very light weight mechanical driven parabolic cylindrical reflector, revolving around the feed assembly, is implemented to provide the 360 degrees azimuth coverage. The number of feed elements and the size of the parabolic cylindrical reflector are selected to satisfy the gain and beam performance needs. The parabolic cylindrical reflector and the symmetrical radiating feed elements are configured to help simplify the implementation of a beam pointing antenna to be placed on a moving vehicle. The design is configured for X-Band operation. However, the design and construction of the apparatus is applicable to other frequencies as well.

### FlELD

This disclosure provides new art in design and fabrication of hybrid electronical and mechanical beam Pointing vehicle antenna for satellite communication

The conical cone element of the feed assembly is configured after the patent application Ser. No. US 13/573,495 antenna structure; the conical cone radiator is radiating over a round small ground plane and is connected to a coaxial cable connector,

### ABSTRACT

A highly efficient electronical and mechanical beam pointing vehicle antenna is disclosed. The structure is designed for a vehicle to maintain continued communication with a satellite while the vehicle is in motion. The structure is comprised of a group of left and right hand circularly polarized elements which are located and fixed to the center of the antenna structure. These feed elements are stacked and are electronically phased to obtain the elevation pointing. The feeds are wrapped around by a vane type polarizer which is designed to provide simultaneous operation of left and right hand circularly polarized signals and the radiation of the feed elements are symmetrically radiated over the entire 360 degree horizontal field of view. A very light weight mechanical driven parabolic cylindrical reflector, revolving around the feed assembly, is implemented to provide the 360 degrees azimuth coverage. The number of feed elements and the size of the parabolic cylindrical reflector are selected to satisfy the gain and beam performance needs. The parabolic cylindrical reflector and the symmetrical radiating feed elements are configured to help simplify the implementation of a beam pointing antenna to be placed an a moving vehicle. The design is configured for X-Band operation. However, the design and construction of the apparatus is applicable to other frequencies as well

### Description

### CROSS REFERENCE TO RELATED APPLICATION

This application claims the benefit of Provisional Application NO. 62/708875 filed on Dec. 28, 2017.

### BACKGROUND

Vehicle antenna in communication satellite while the vehicle is in motion require rapid beam forming capability and the ability to point the antenna beam in its desired direction continuously.

If not for the complexity and cost issue, a complete electronic & beam forming antenna would be choice because its ability to form arid point a beam more rapidly.

However, in a high gain array system, a large number of elements are required a and the elements must be positioned and excited properly in order to form the desire array beams.

In general, a reflector antenna is simpler to implement but the drawback is that the reflector antenna does not have the same agility as total electronic array, not to mention the short falls associated with mechanical parts.

Because the cost and complexity issue associate with the total electronic array and the problems associated with the total mechanical reflector antenna system, the hybrid array antenna is considered excellent compromise solution. For this reason, an embodiment hybrid array is configured.

The structure composes a stack of feed elements that are wrapped around by a vane type polarizer and the entire feed assembly is located and fixed to the center of the antenna structure.

A very light weight mechanical driven parabolic cylindrical reflector, revolving around the feed assembly, is designed to provide the desired 360 degree azimuth coverage.

The elevation coverage is provided by the feed assembly and by phasing the feed elements tee obtain radiation reflecting the parabolic cylindrical reflector.

### DETAIL DESCRIPTION

This disclosure, an X band hybrid array consists of feeds of conical horns and a parabolic cylindrical reflector. This is scalable to upper and lower frequency bands including C band, KU and Ka bands.

FIG. 4 is the X Band antenna consisting of several major parts. They are uniquely implemented to provide simultaneous left and right hand polarization radiation with good isolation. The transmitting and receiving, feeds are of the same design and they are conical horns operating over a small ground plane. Each horn is wrapped around by a vane type polarizer.

The polarizers are formed with narrow parallel metal stripes and are separated less than tenth of a wavelength-and are orientated approximately + and 45 degrees with respect to the vertical axis.

The tilting orientation is designed to obtain the needed quadrature phase for obtaining circular polarization of left and right hands; the orientation of the polarizer vanes for left and right hand polarizers are perpendicular to each other. Therefore, the left and right hand polarizers are identical in design except the orientation is reversed to one another along the vertical axis.

The polarizers are designed to ensure that good isolation is obtained between the feed elements. Strong isolation is a very important performance factor foe the antenna in support of communication system.

The light weight parabolic cylindrical reflectors designed to focus the radiation energy from the antenna feed elements to produce the required antenna high gain beams for continue pointing and maintain communication with a satellite while the vehicle is in motion.

Because the application of a light weight parabolic cylindrical reflector, the number of antenna elements required to form high gain beams are greatly reduced, along with a simplification of its feed network. As a result, the hybrid antenna system with a continued pointing capability for moving vehicle can be produced economically.

### DRAWINGS

FIG. 1—Cone Feed Element

FIG. 1 is a prospective view of a preferred embodiment of the subject invention containing a group of cone radiator 1 and each cone radiator operates over a round small ground plane 2 through a SMA type of connector 3 The ground plane measures approximately 0.4 wavelengths and about 0.6 inches. The cone angle 4 of the cone radiator is 90 degrees and a smaller cone angle less than 90 degrees may also be applied. However, the input impedance of the feed element will be changed, accordingly. The size of cone angle may be selected to help achieve the desire input impedance. Stamping and machining may be used to fabricate the cone part and 3D printing is also a good fabrication choice.

FIG. 2—Polarizer

FIG. 2 is a prospective view of a preferred embodiment of food element polarizer 2a and 2b containing a group of parallel metal stripes 5 which is designed to provide a quadrature phase needed for generating a circular polarization for the feed element. The stripes are spaced 6 evenly less than 0.1 of a wavelength and a separation approximately 0.15 inches. The stripes are tilted approximately 45 degrees 7 with respect to the vertical axis. The polarizer wraps around each feed element. When the polarizer whose stripes are orientated +45 degrees in FIG. 2a, the vertical outgoing wave from the cone element is changed to two orthogonal components, and horizontal, and the horizontal component is delayed by 90 degrees and as a result, left hand polarization is formed. When the stripes of the polarizer are orientated 45 degrees in FIG. 2b, the right hand polarization is formed. The feed element and its polarizers are positioned alternately; the left hand polarization feeds and the right hand polarization feeds are spaced and interlaced approximately one wavelength apart. The height of each feed element is measured about one half of a wavelength, approximately 0.75 inches 8.

FIG. 3—Parabolic Cylindrical Reflector

FIG. 3 presents a prospective view of a preferred embodiment reflector 9 which is configured to focus the radiation from the feed elements to form high gain beams. The reflector is designed to revolve around the stationary feed assembly to provide horizontal coverage of 360 degrees. The reflector is mechanically operated for pointing the reflector, with inputs from knowing the satellite and vehicle location. The reflector is made of rigid material such as graphite with metallic coating and supported by brackets to allow the step motor to point the reflector to its desired position. The width 10 of the reflector is measured approximately 8 inches and the vertical dimension 11 is also measured approximately 8 inches for providing an antenna gain approximately 20 DBIC.

FIG. 4—Hybrid Antenna Assembly Prospective View

FIG. 4 presents the prospective view of the entire antenna assembly containing all major parts including the fiber glass protective cover 12. The interconnecting coaxial cables are not shown. Also not shown are ail the feed cable that are connecting the feed elements to its equal division power divider individually through a phase shifter. There are two major input ports 13 and 14, one port is for transmit function and the second port is for receive function; these ports are for connection to transmitter and to receiver respectively.

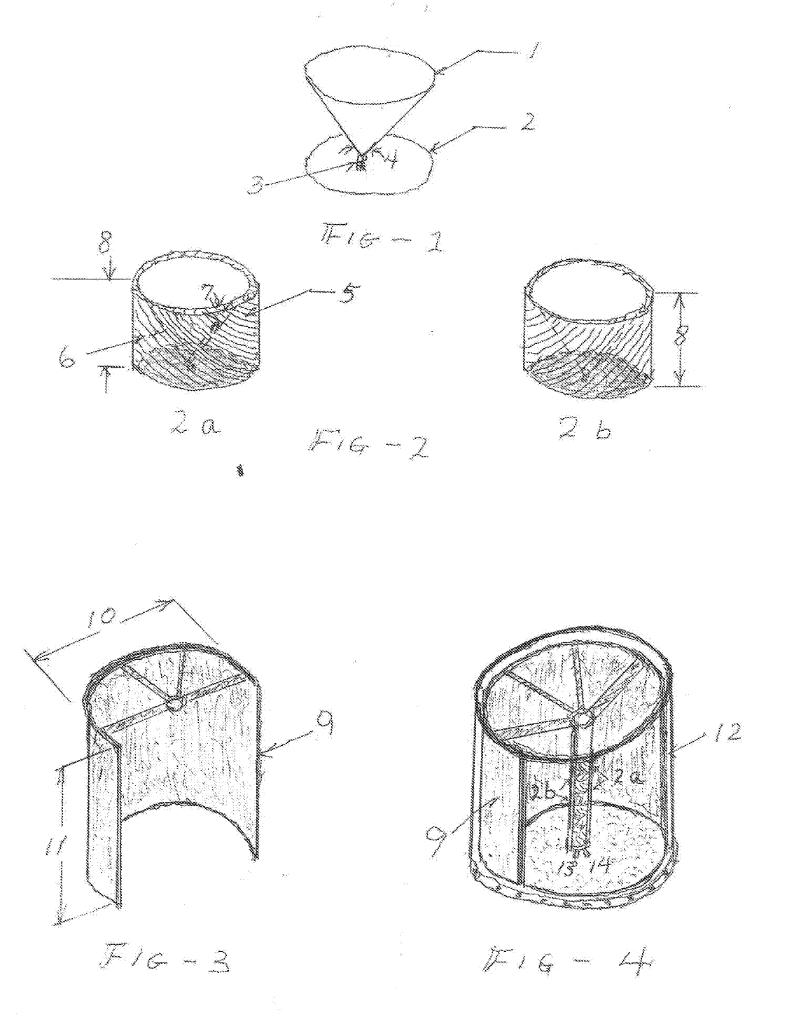

1. A highly efficient hybrid electronical and mechanical structure is disclosed; the structure contains a group of left and right hand circular polarized elements of conical cones that are inter connecting and perform together as an array with polarizer wraps around and is located and fixed to the center of the structure; a light weight parabolic cylindrical reflector, revolving around the feed assembly, is incorporated to focus the radiation from the feed assembly to point a beam to a satellite for continued communication, while the vehicle is in motion; the entire structure is protected by a fiberglass enclosure;

2. The structure described in claim 1 contains a group of left and right hand circular polarization radiating element of conical cones which are staged alternately and inter connecting and performing as a left and right hand polarization array;

3. The structure described in claim 2 that the conical one is operated over a small ground plane where the cone axis is positioned perpendicular to the ground plane and the cone tip is connected to a SMA connector which is mounted to the round plane for input connection to a coaxial cable;

4. The structure described in claim 2, the conical cone feed elements are each wrapped around by a vane type polarizer which are formed by a group of parallel metal stripes that are orientated and −45 degrees from the vertical axis to provide the desired left and right polarization radiation;

5. The structure described in claim 2 is rigidly mounted and located in the center of the structure, and is protected by a thin ray dome;

6. The structure described in claim 2 that the feed elements are connected to an equal power division power divider through a phase shifter;

7. The structure of claim 1 consists of a parabolic cylindrical reflecting surface which is configured to focus the radiation from the feed assembly to form a beam to continue pointing to a satellite while the vehicle is in motion; the reflector is fabricated from strong light weight material such as graphite material coated with a metallic surface; the reflector is mechanical driven by a mechanism such as a step motor operated on information of the location of the satellite and vehicle and these information are readily known:

8. The structure of claim 7 is supported rigidly by brackets an rides on a roller bearing type mechanism;

9. The entire claim 1 structure is protected by a fiberglass enclosure.
